(19) United States
(12) Patent Application Publication
(10) Pub. No.: US 2003/0078848 A1
(43) Pub. Date: Apr. 24, 2003

(54) Sales information management apparatus and sales information management system

(75) Inventors: Yutaka Noguchi, Maebashi (JP); Mamoru Matsumoto, Maebashi (JP); Junichi Takahara, Maebashi (JP); Toru Sakaino, Maebashi (JP); Tomoaki Nakai, Maebashi (JP); Hiroki Fukazu, Maebashi (JP); Toshihiro Eda, Maebashi (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/093,631

(22) Filed: Mar. 11, 2002

(30) Foreign Application Priority Data
Oct. 24, 2001 (JP) 2001-325761

(51) Int. Cl. G06F 17/60

(52) U.S. Cl. 705/22

(57) ABSTRACT

The sales information management apparatus (store server) has preset requirement for the prompt sales report, and when the requirement is satisfied, it gives a message (for example, E-mail) signaling that the requirement is satisfied, to the person in charge of the corresponding commodity at the store. By this notice, the person in charge can grasp necessary information for the prompt sales report at virtually real time without traveling to the place where the store server is installed, and also he/she can quickly take proper actions (replenishment of commodity so as not to miss a sales opportunity, discount to prevent commodity from being left unsold, etc.).

### BACKGROUND OF THE INVENTION

1. Field of the Invention

The present invention relates to a sales information management apparatuses and a sales information management system that manage sales information on each commodity accumulated by a point of sales (POS) system.

2. Description of the Related Art

FIG. 17 is a schematic diagram of a POS system installed in a store. As shown in FIG. 17, the POS terminal 1 that adds to the total prices of goods purchased by customers transmits sales information on the commodity to the host apparatus 2 when a customer makes payment. The POS terminal 1 and the host apparatus 2 are connected together by a LAN or the like. As the host apparatus 2, for example, a store server (SSV) arranged in the office (backyard), etc. in the store can be used.

The store server (SSV) 2 aggregates sales information on each item, including the number of purchasers, the quantity of sales, the amount of sales, discounts and taxes, on monthly and daily bases as well as in the time period from the opening hour to the present hour of the current day. Such aggregation can be made on the basis of each single item (commodity name), commodity category (commodity department such as fresh fish, meat, canned foods, noodles), responsible persons (store employees in charge of each item or the commodity department), type of customers (senior citizens, middle-aged persons, children, men, women), POS terminals (POS terminal ID) or type of transactions (cash, notes,credit cards). As to sales information on the aggregation made on the basis of each time period, the aggregation made in the period from the opening hour to the present hour of the current day is called “prompt sales report.”

Regarding the utilization of the prompt sales report, so far, the person in charge has done no more than output the report (display on the screen or printout output) from the store server 2 installed in the store office as required, to grasp the sales conditions.

FIGS. 18A and 18B are examples of the display screen of the store server 2. When the person in charge selects the prompt news from the menu screen in FIG. 18A, the prompt sales report for each item is displayed as shown in FIG. 18B.

Such a prompt sales report is extremely important information for store management because it is information to prompt actions such as the execution of discount on commodity (for example, in the case of commodity left unsold), the replenishment of commodity to be displayed on the shelves (in the case of a large number of commodity sold).

Conventional utilization of the prompt sales report, however, has the following problems:

First, checking the prompt sales report and actions to respond to the report depend entirely on the person in charge, and proper actions based on the report may not be taken. For example, if a product has been sold more than anticipated and the person in charge forgets to check the prompt sales report, the quantity of the products on the shelves will decrease and the store may miss a sales opportunity. In the present situation, actions to respond to the prompt sales report depend entirely on the person in charge, and if the person is inexperienced, proper actions may not be taken.

Secondly, the person in charge has to stop working in the store for a while and goes out to operate the store server 2 in order to check the prompt sales report. In general, only one unit of the store server 2 is installed, and therefore, more than one person in charge cannot check the prompt sales report on their respective products at the same time.

Thirdly, the store superintendent (for example, store manager) cannot grasp the requirement of executing actions to respond to the prompt sales report. As the contents of actions taken on the basis of the prompt sales report are not registered in the store server 2, the store superintendent cannot check what actions each person in charge is performing.

### SUMMARY OF THE INVENTION

In view of the above problems, it is therefore the object of the present invention to provide a sales information management apparatus and a sales information management system that can more efficiently make use of the prompt sales report (sales information) collected by the POS system.

The sales information management apparatus (store server) provided by the present invention to achieve the above object has preset requirement for the prompt sales report, and when the requirement is satisfied, it gives a message (for example, E-mail) signaling that the requirement is satisfied, to the person in charge of the corresponding commodity at the store. By this notice, the person in charge can grasp necessary information for the prompt sales report at virtually real time without traveling to the place where the store server is installed, and also he/she can quickly take proper actions (replenishment of commodity so as not to miss a sales opportunity, discount to prevent commodity from being left unsold, etc.). When the person in charge receives such a message, he/she has to reply whether he/she takes any action to the message, and the sales information management apparatus checks whether there is a reply to the message from the person in charge. By doing so, it can prompt the person in charge to take actions, and the superintendent can grasp in detail the working conditions of the person in charge.

The sales information management system provided by the present invention to accomplish the above purpose comprises the sales information management apparatus of present invention and a terminal (for example, a cellular phone) to receive the above message sent from the apparatus.

The sales information management system further comprises a network server connecting to the sales information management apparatus and terminal via a network, and the sales information management apparatus uploads sales information to the network server. Then, terminal obtains the uploaded sales information from the network server, enabling the person in charge carrying the terminal to check the sales information at any place in the store, and also enabling more than one person in charge to check the respective sales information at the same time.

### BRIEF DESCRIPTION OF THE DRAWINGS

FIG. 1 shows a configuration example of a sales information management system in accordance with the embodiment of the present invention;

FIG. 2 shows an example of the display to set requirement No. 1;

FIG. 3 shows an example of the display to set requirement No. 2;

FIG. 4 shows an example of the display to set requirement No. 3;

FIG. 5 shows an example of the requirement history table;

FIG. 6 is a flowchart of processing message notices in this embodiment;

FIG. 7 shows an example of the “unsent” table;

FIG. 8 shows an example of the display of a message to be sent;

FIG. 9 shows an example of the “sent” table;

FIG. 10 shows an example of the log-in display;

FIG. 11 shows an example of the commodity department input display;

FIG. 12 shows an example of the display of prompt sales report by items;

FIG. 13 shows an example of the reply display;

FIG. 14 is a flowchart of the reply monitor processing;

FIG. 15 shows an example of the action execution status display;

FIG. 16 shows an example of the display of the action execution status history for each person in charge;

FIG. 17 is a schematic diagram of a POS system installed in a store; and

FIGS. 18A and 18B show examples of the display screen of the store server 2.

### DESCRIPTION OF THE PREFERRED EMBODIMENT

A preferred embodiment of the present invention will now be described. It is to be understood however that the technical scope of the present invention is not limited to the above embodiment.

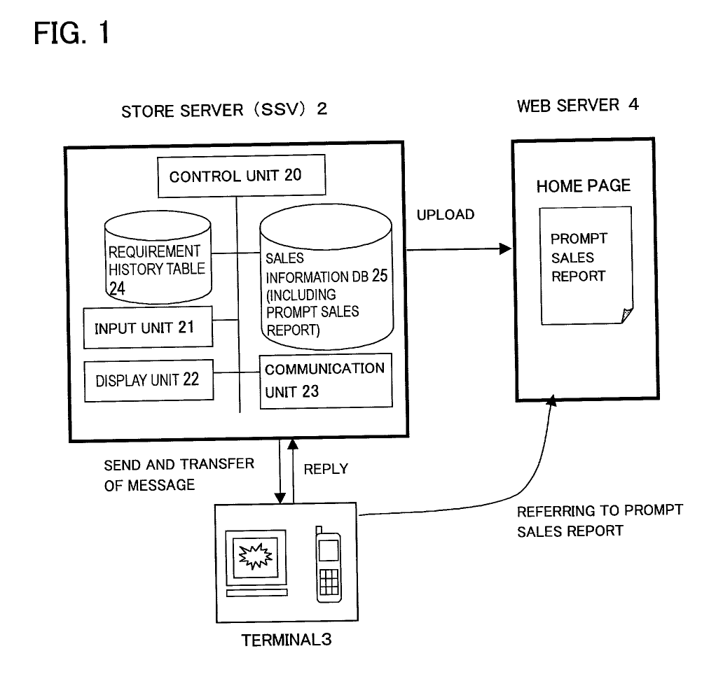

FIG. 1 is a configuration example of a sales information management system in accordance with the embodiment of the present invention. The sales information management system comprises a store server (sales information management apparatus) 2 in a POS system and a terminal 3 connected with the store server 2 via a network (for example, the Internet). It is desirable that a portable terminal carried by the person in charge at the store, such as a cellular phone, a notebook personal computer or a PDA terminal is used as the terminal 3. A desktop personal computer can also be used as the terminal 3 in addition to portable terminals.

The control unit 20 of the store server 2 consists of a CPU and the like, and executes each function in this embodiment described later. The input unit 21 consists of a keyboard and a mouse to input the message notice requirement, etc. described later. The display unit 22 is a display. The communication unit 23 communicates with a POS terminal not shown in the diagram via a LAN installed in the store, and communicates with the terminal 3 and the Web server described later via a network such as the Internet. The requirement history table 24 is a table characteristic of this embodiment. The sales information database 25 is a database to accumulate sales information transmitted from the POS terminal.

The store server 2 in this embodiment is equipped with a message notice function that monitors (checks) the prompt sales report, the aggregate of sales made in the period from the opening hour to the present time of the current day, and gives a special message to the terminal 3 when the prompt sales record satisfies the specific requirement, and a replymonitor function that checks if there is a reply to the message from the portable terminal 3, in addition to a function that aggregates sales information from the POS terminal in the POS system. The store server 2 is also provided with a sales information upload function that uploads sales information to the Web server (network server) 4 on a network. The processing in the sales information management system in this embodiment is described in detail as follows.

(Setting of Requirement)

The person in charge sets the specific requirement on the prompt sales report into the store server 2 by operating the requirement setting screen. The store server 2 monitors sales information aggregated as required, and gives a special message to the terminal 3 of the person in charge via E-mail when the set requirement is satisfied.

The requirement include, for example, “the amount of money or quantity of a specified item sold exceeds the designated value” (requirement No. 1), “the amount of money or quantity of a specified item sold at the designated time” (requirement No. 2) and “the amount of money or quantity of a specified item sold is abnormal” (requirement No. 3).

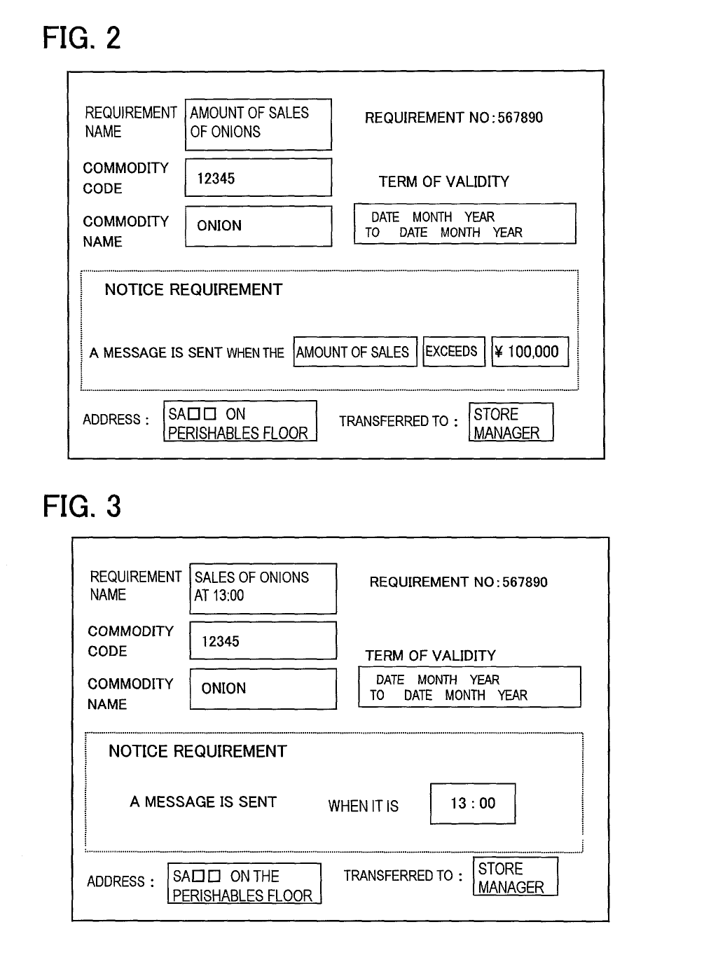

FIG. 2 is an example of the display to set requirement No. 1. When the setting menu for the desired requirement is selected from the menu display not shown, the requirement setting display as shown in FIG. 2 is shown. The identification number (requirement number) that identifies each set requirement is assigned to the requirement setting display.

The person in charge inputs the specified contents of the requirement into the requirement setting display. In FIG. 2, the contents of the requirement include, for example, requirement name, commodity code, commodity name, notice requirement, address, requirement setting period, etc. The requirement name is a name by which the person in charge can identify the desired requirement, and the person in charge can give a desired name. A commodity of which the person is in charge and its commodity code are input in the commodity name and commodity code sections, respectively.

The setting period is the term for which the set requirement is valid, and the store server 2 monitors for the setting period if the set requirement is satisfied.

An E-mail address of the person in charge is input in the address section. Alternatively, if the name corresponding to his/her mail address is registered in the address book of the store server 2, that name can be input. The address for transfer is, as described later, another address to which the message is transferred when there is no reply from the address after a message is sent to his/her address. For example, an E-mail address of the store superintendent can be used as the address for transfer.

After the amount of sales or quantity of sales is selected from the pull-down menu, the value corresponding to the selected amount of sales or quantity of sales is input in the notice requirement section. According to this requirement, the store server 2 monitors the prompt sales report, and gives a message to the address when the amount of sales (or the quantity of sales) of an item whose commodity code is input reaches the set value (set quantity) that serves as the reference value.

FIG. 3 is an example of the display to set requirement No. 2. The requirement name, commodity name, commodity code address, address for transfer, setting period are the same as the display in FIG. 2.

The time is input in the notice requirement section in FIG. 3. For example, the time selected from the pull-down menu can be input. According to this requirement, the store server 2 sends a message containing the amount of sales and quantity of sales of an item whose commodity code is input, at the time of inputting the item.

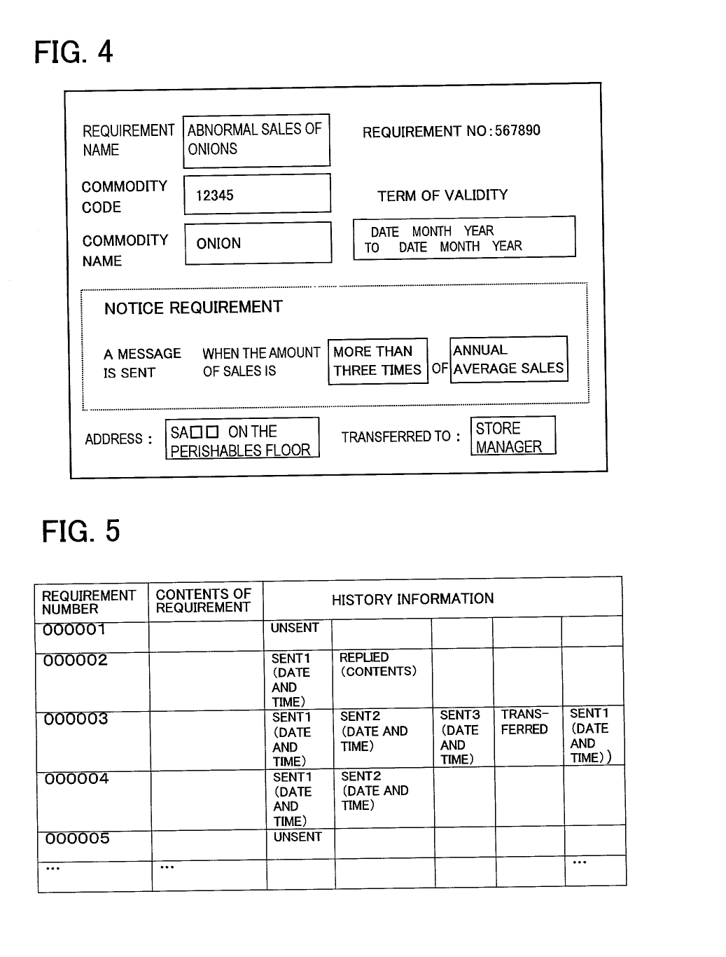

FIG. 4 is an example of the display to set requirement No. 3. The requirement name, commodity name, commodity code address, address for transfer, setting period are the same as the display in FIG. 2.

The amount of deviation from the reference value set for the amount of sales or quantity of sales is set as the notice requirement in FIG. 4. For example, the annual average amount of sales (or annual average quantity of sales) is used as the reference value. As for the reference value, month or week can be used instead of year, and maximum and minimum can be used instead of average. Such statistical information for reference is accumulated in the store server 2. The amount of deviation is set, for example, more than 3 times, less than half, etc.

The requirement set on the displays in FIGS. 2 to 4 are registered in the requirement history table 24.

FIG. 5 is an example of the requirement history table. The contents of the requirement is registered according to each requirement number, and history information on each requirement is also registered in the requirement history table 24. As to the history information, if no message is sent (noticed) during the term for which the set requirement is valid, “unsent” is registered as the initial status. If one or more messages are sent, the data and time of sending each message and the contents of the reply in the case that a reply to the message is received, and the date and time of transfer of the message if it is transferred are registered.

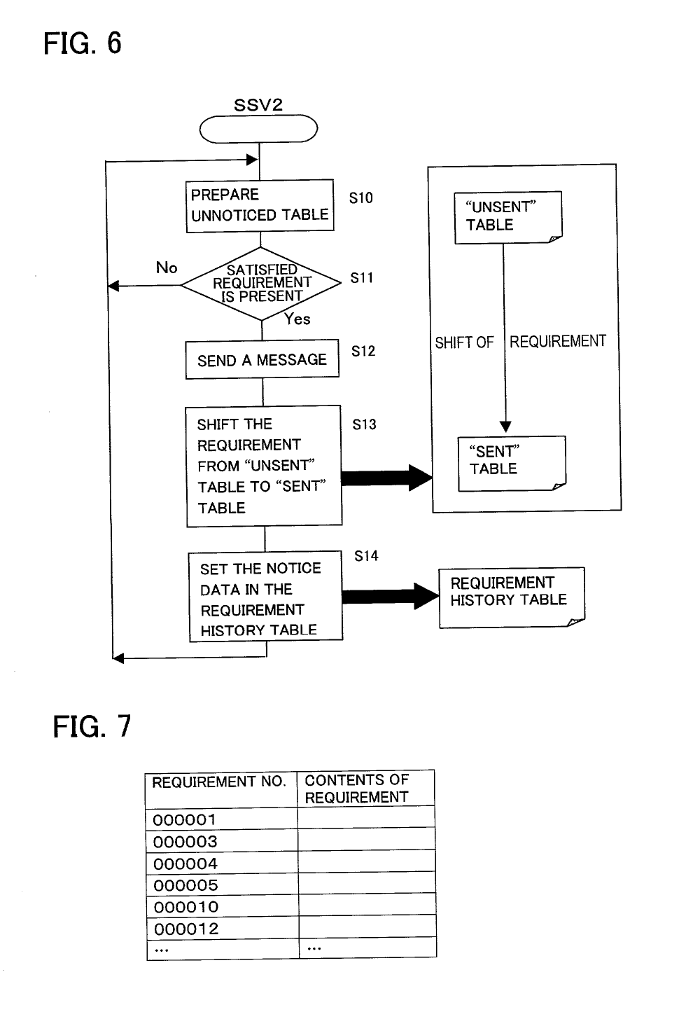

FIG. 6 is a flowchart of processing message notices in this embodiment. In FIG. 6, the store server 2 selects the requirement whose setting period includes the current day from the requirement history table 24, and prepares an “unsent” table, a list of the selected requirement, before daily business starts (before the store opens) (S10).

FIG. 7 is an example of the “unsent” table. The contents of each selected requirement (requirement number, requirement name notice requirement, address, address for transfer, etc.) are registered in the “unsent” table. After preparing the “unsent” table, the store server 2 monitors the prompt sales report in the sales information database 25 and judges at designated intervals whether or not each of the requirement registered in the “unsent” table is satisfied (S11). If any of the requirements is met, it sends a message indicating the requirement to the address (S12).

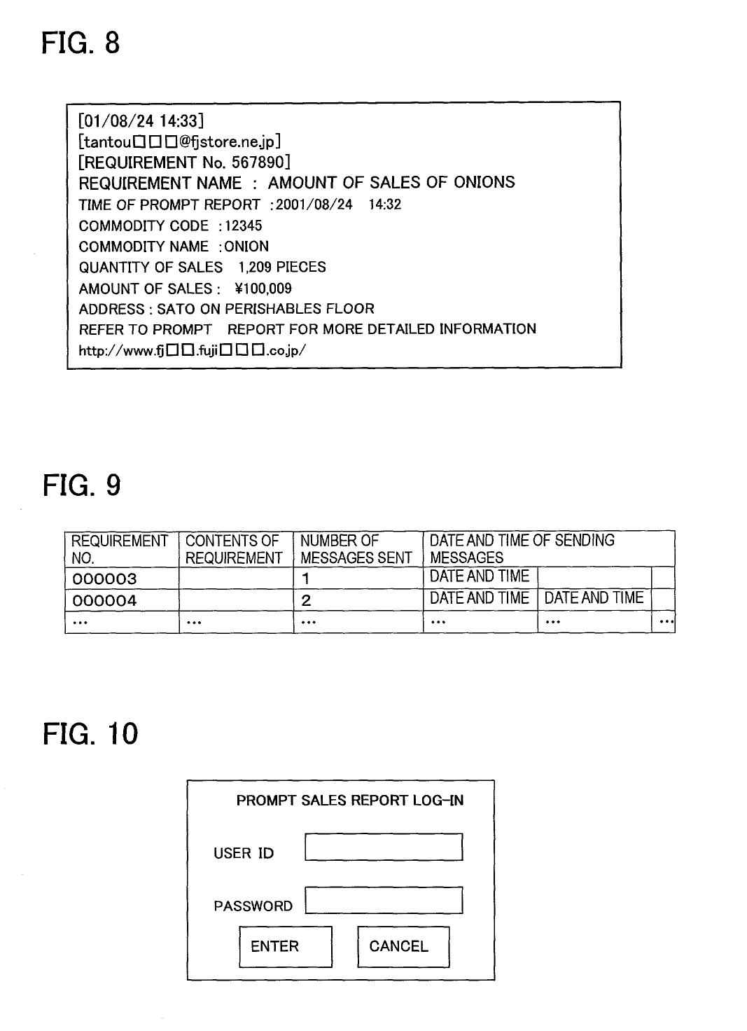

FIG. 8 is an example of the display of a message to be sent. An example of a message via E-mail to be shown on the screen of the portable terminal 3 of the person in charge is displayed in FIG. 8. The message in FIG. 8 is a message responding to the requirement that the amount of onions sold exceeds ¥100,000. The store server 2 detects that the amount of the sales has exceeded ¥100,000, from the prompt sales report shown in the message section in FIG. 8 at the time of the prompt report, and gives a message. The message contains requirement number, requirement name, commodity code, commodity name, address, and the quantity and amount of sales at the time when any requirement is met, as shown in FIG. 8.

Referring back to FIG. 6, when detecting a message, the store server 2 moves the requirement corresponding to the message from the “unsent (unnoticed)” table to the “sent (notice completed)” table (S13). More specifically, the server deletes the corresponding requirement from the “unsent” table and adds it to the “sent” table.

FIG. 9 shows an example of the “sent” table. Requirement informed by messages are registered in the “sent” table on the current day, and the contents registered in the “sent” table are cleared (erased) every day after the store is closed. In this way, the above “unsent” and “sent” tables are temporary tables that are newly prepared day by day. In addition to the contents of requirement (requirement name, commodity code, commodity name, contents of requirement, address, etc.) corresponding to each requirement number, the date and time of sending a message (all of the dates and times if more than one message is sent), and the number of sending are registered in the “sent” table.

After giving a message, the store server 2 registers the “date and time of sending” as notice data responding to the corresponding requirement in the requirement history table (S14).

When receiving a message, the terminal 3 of the person in charge informs him/her of the reception of the message by alarm sound or vibration. In this way, the person in charge can immediately receive and check a message shown on the screen of the terminal 3.

Therefore, the person in charge can check for the satisfaction of any requirement at any place without returning to the store office periodically, and also can avoid missing a suitable time to execute necessary actions. By making an experienced person set requirement, proper contents of requirement can be set, enabling the support for inexperienced persons in charge.

(Uploading of Prompt Sales Report)

The store server 2 uploads the prompt sales report to the Web server 4 periodically. Using the terminal 3 that can be connected with the Web server 4 via a network, each person in charge can make access to the URL (Uniform Resource Locator) uploaded with the prompt sales report and can check the report at any place.

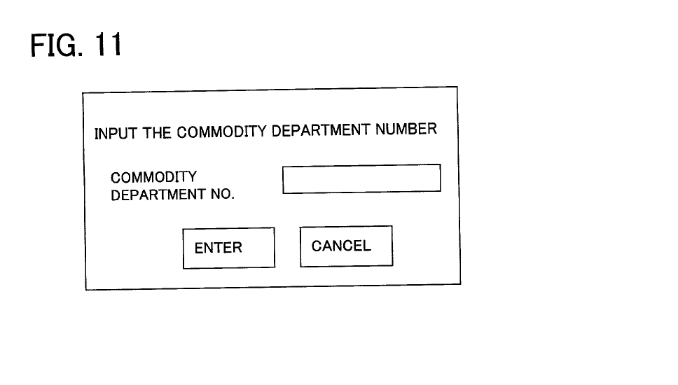

The URL of the prompt sales report can be attached to a message given when the above requirement is met (Refer to FIG. 8). By specifying the URL of the prompt sales report on the terminal 3, the log-in display as shown in FIG. 10 is shown. When the person in charge inputs the pre-registered user ID and password, the commodity department input display as shown in FIG. 11 is shown. When the person in charge inputs the commodity department code for the item of which he/she is in charge, the Web site of the prompt sales report for each item included in the commodity department is displayed.

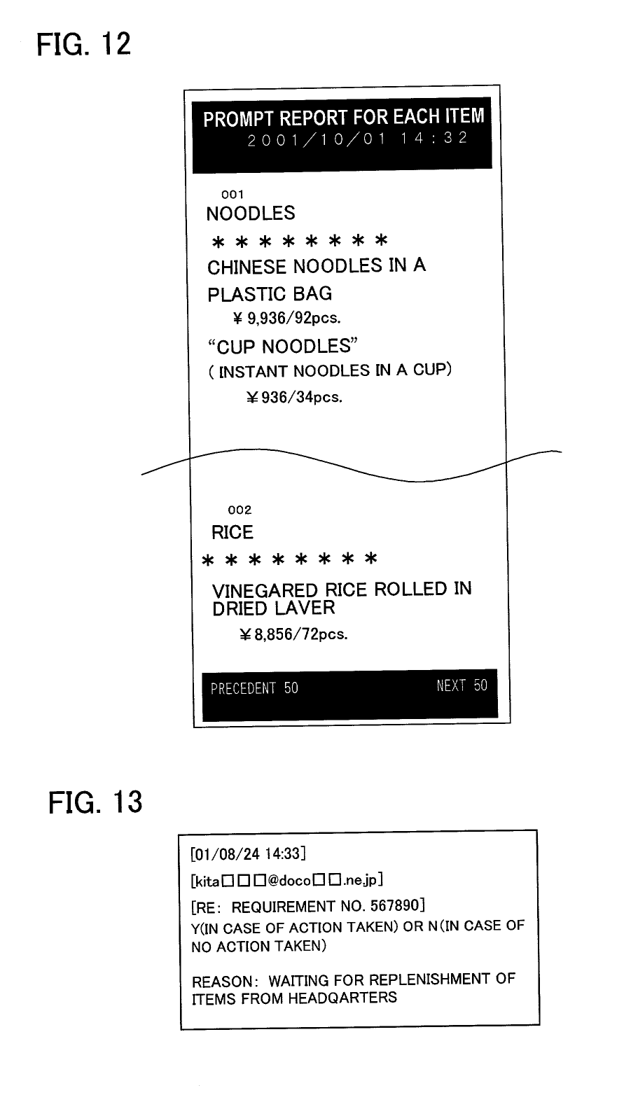

FIG. 12 is an example of the display of prompt sales report by items. As shown in FIG. 12, the latest quantity and amount of sales of each item included in the specified commodity department are displayed. In this way, the person in charge can immediately check the sales requirement of items other than those whose requirement contained in messages are met (other items in the same department or related items in different departments).

Therefore, by uploading the prompt sales report to the Web server 4 on a network and by operating the terminal 3 to access the Web server 4 from where he/she is, the person in charge can check the prompt sales report as required. Furthermore, more than one person can check their desired prompt sales report at the same time.

(Monitoring of Replies)

The person in charge needs to reply whether or not an action corresponding to a message should be taken. To do so, first, the person in charge shows the message reply display on the terminal 3.

FIG. 13 is an example of the reply display. By operating the terminal 3, the person in charge inputs the letter Y (in the case that an action is taken) or N (in the case that no action is taken) in the first line of the reply section, depending on whether an action is taken or not. Then, he/she inputs the reason in the second line of the reply section if no action is taken. A reply is sent from the terminal 3 to the store server 2. When receiving the reply, the store server 2 identifies the requirement from the requirement number included in the title, check the letter in the first line of the reply section and judges whether an action is taken or not. If there is input in the second line, the server is set to perceive the reason for no action.

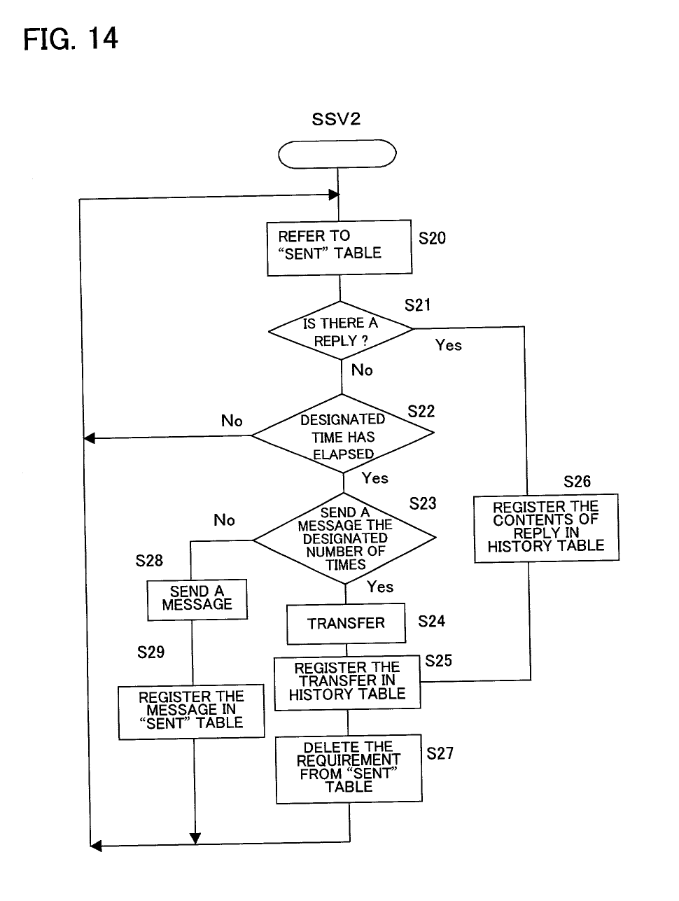

FIG. 14 is a flowchart of the reply monitor processing. In FIG. 14, the store server 2 stores incoming replies, refers to the “sent” table at specified intervals (S20) and checks if there is a reply responding to the requirement registered in the “sent” table (S21). Or after receiving a reply, the server can check the “sent” table to retrieve the requirement corresponding to the received reply. As to the requirement replied, the store server 2 sets the contents of the reply (action or no action taken, reason for no action) for the requirement history table (S26), and deletes the requirement from the “sent” table (S27). As to the requirement not replied, it checks if the designated time (for example, 15 minutes) has elapsed since the time of sending the previous message (S22), and if so, it checks if the number of messages sent reaches the designated number (for example, 3 times) (S23). If not, it resends a message to the terminal 3 (S24), registers the date and time of resending the message in the “sent” table and updates the number of messages sent by adding +1 (S29). If the number of messages sent reaches the designated number, the store server 2 transfers the message to the address for transfer (S24). After transfer of the message, the store server 2 sets the contents of transferring (Date and time of transferring, address of transferring, etc.) for the requirement history table (S25) and deletes the requirement from the “sent” table (S27).

As described above, if there is no reply to a message (in other words, if no action is taken), the message is resent the designated number of times to prompt the implementation of any necessary action. If there is still no reply from the person in charge, the message is transferred to the store superintendent. In this way, it is possible to urge the superintendent or the like to take the necessary action and reinforce the execution of necessary actions which have depended entirely on the person in charge.

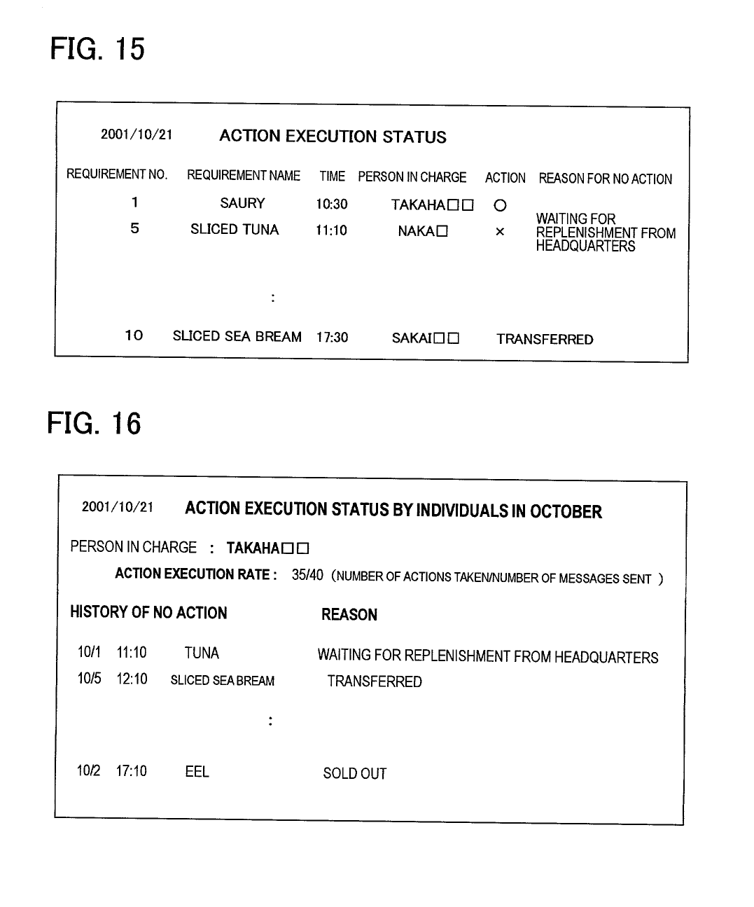

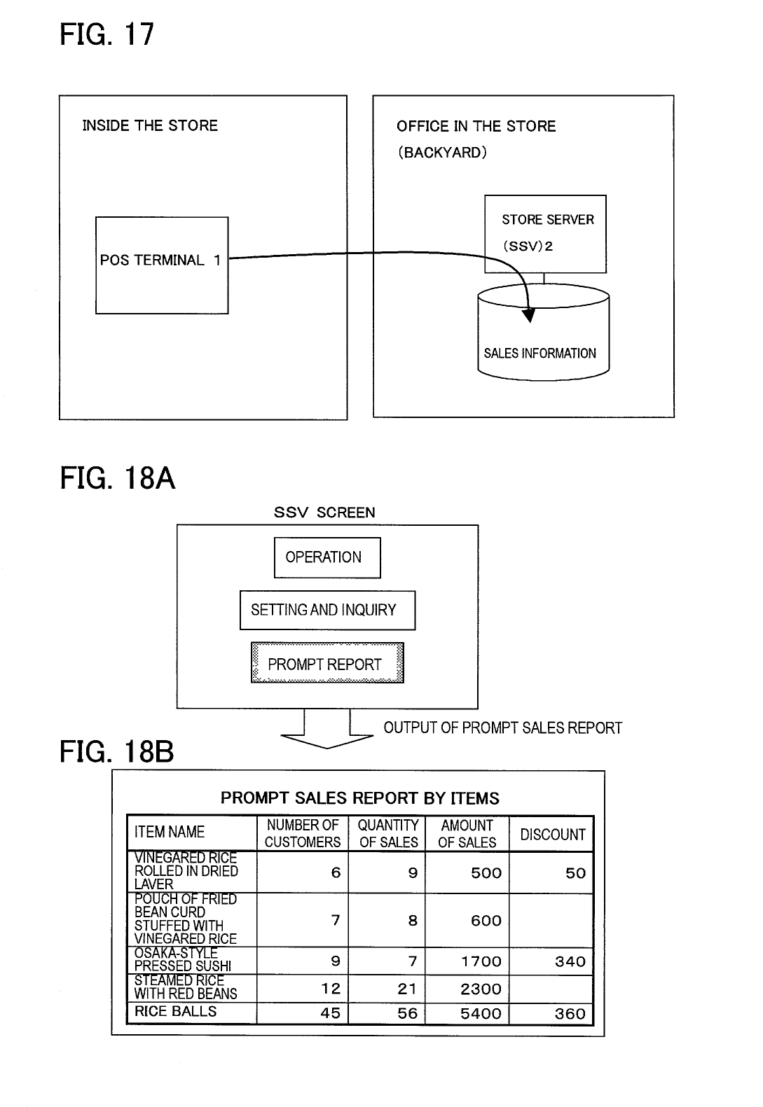

FIG. 15 is an example of the action execution status display. The store server 2 displays the action execution status as shown in FIG. 15. The action execution status is displayed on a daily basis and corresponds to a message sent on the current day. The store server 2 selects both the requirement corresponding to the message sent on the current day and the execution status of the action corresponding to the message from the requirement history table, prepares the action execution status and displays it on the screen. The store server 2 refers to the requirement history table periodically (for example, every 5 minutes) and updates the displayed action execution status. By checking this action execution status, the store superintendent can grasp which requirement is satisfied and what action is taken by the person in charge every day.

FIG. 16 is an example of the display of the action execution status history for each person in charge. The store server 2 displays the action execution status history for each person in charge as shown in FIG. 16 according to the requirement history table. The action execution status history for each person in charge is a history of actions taken by each person in charge for the specified period (for example, 1 month). The action execution rate (the number of actions taken/the number of messages sent (excluding the number of messages resent) and the history of no action (date and time of sending messages, commodity name, reason for no action) are displayed. By making use of this action execution status history for each person in charge, the store superintendent can evaluate the work performance of each person in charge. The superintendent can also include the number of actions executed, the number of reminders (the number of messages resent) and the number of messages transferred in the evaluation of the work performance of each person in charge.

In the above embodiment, an example of setting requirement for a single item is described. Requirement for more than one item (for example, several items included in a commodity department or all the items of which the person takes charge) can also be set.

Not only the amount and quantity of sales of each item but also the number of purchasers can also be used as a requirement set for the item.

If there is no reply to a message, and if no reply is received within the designated time without resending the message as a remainder plural times, then the message can instantaneously be transferred to another address.

According to the present invention, when any of the preset requirement for the prompt sales report is satisfied, a message informing of the satisfaction of the requirement is sent to the person in charge of the corresponding commodity at the store. By this notice, the person in charge can grasp necessary information for the prompt sales report at virtually real time without traveling to the place where the store server is installed, and also he/she can quickly take proper actions according to the sales requirement. For example, even if only a small quantity of pieces of an item is left on the shelf because the item has been sold more than expected, the person in charge can take a action such as replenishment of the item so as not to miss a sales opportunity, by receiving a message at real time. Or if an item has not been sold as anticipated, the person in charge can prevent the item from being left unsold by taking an action such as discount, by receiving a message at real time. In addition, by demanding a reply from the person in charge as to whether or not any action is taken, it is possible to prompt him/her to take actions, and the superintendent can grasp in detail the working requirement of the person in charge.

The scope of protection of the present invention is not limited to the above embodiment of the invention, but covers the invention defined by claims and its equivalent.

What is claimed is:

1. A sales information management apparatus for managing sales information on the sales of each item, comprising:
a checking unit for checking the satisfaction of a predetermined requirement set for sales information on at least one item; and
a communication unit for sending a message to inform of the satisfaction of the requirement when the requirement set is satisfied.

2. The sales information management apparatus according to claim 1, wherein the sales information includes a prompt sales report which is the sum of at least either the amount of money or the quantity of sales of each item in the period from the opening hour to the present time of the current day.

3. The sales information management apparatus according to claim 2, wherein the requirement is whether or not the amount of money or the quantity of sales reaches a predetermined reference value or its relevant value.

4. The sales information management apparatus according to claim 2, wherein the message includes the prompt sales report on the time when the requirement is satisfied.

5. The sales information management apparatus according to claim 1, wherein the communication unit sends the message to an addressee set in the requirement.

6. The sales information management apparatus according to claim 5, wherein the checking unit checks if there is a reply to the message from the addressee.

7. The sales information management apparatus according to claim 6, wherein if the reply is not received within a specified time after the message is sent, the communication unit transfers the message to another addressee.

8. The sales information management apparatus according to claim 7, wherein the communication means resends the message to the addressee at least once before transferring the message.

9. The sales information management apparatus according to claim 6, further comprising a storage unit for storing, for each set requirement, history information on history concerning the notice of the message and concerning the presence or absence of a reply to the message.

10. The sales information management apparatus according to claim 6, wherein the reply contains information on whether or not any action corresponding to the message is taken.

11. A sales information management system for managing sales information on the sales of each item, comprising:
a store server for checking the satisfaction of a predetermined requirement set for sales information on at least one item and for sending a message to inform of the satisfaction of the requirement when the requirement set is satisfied; and
a terminal that receives the message.

12. The sales information management system according to claim 11, further comprising a network server connected to the store server and the terminal via a network, wherein the store server uploads the sales information to the network server, and the terminal acquires the uploaded sales information from the network server.

13. The sales information management system according to claim 11, wherein the store server sends the message to a terminal of an addressee set in the requirement.

14. The sales information management system according to claim 13, wherein the store server checks if there is a reply to the message from the terminal of the addressee.

15. A terminal that receives the message sent from the sales information management apparatus of claim 1.
